(19) United States
(12) Patent Application Publication
(10) Pub. No.: US 2018/0202403 A1
(43) Pub. Date: Jul. 19, 2018

(54) DUAL FUNCTION FUEL INJECTOR WITH TUNABLE INTRA-PORT AIR & FUEL FLOW CONTROL

(71) Applicant: Reggio Dwayne HUFF, Brookings, SD (US)

(72) Inventor: Reggio Dwayne HUFF, Brookings, SD (US)

(21) Appl. No.: 15/732,877

(22) PCT Filed: Jul. 13, 2016
(86) PCT No.: PCT/US2016/000059

§ 371 Date: Jan. 11, 2018

(51) Int. Cl. F02M 61/16; F02M 61/18; F02M 69/04; F02M 51/06

(52) U.S. Cl. CPC F02M 61/162; F02M 51/061; F02M 69/047; F02M 61/1813

(57) ABSTRACT

In the preferred embodiments an air flow diverting blade is integral to a base that doubles as a collar designed to coaxially attach to the tip end of a typical port fuel injector for internal combustion engines.

Upon simple manual manipulation of the set rotational angle of the typically externally exposed portion of the port fuel injector along its longitudinal axis, as typical modern port injection systems allow after installation, the angle of the intra-port flow diverting blade can be selectively varied to either straighten existing swirl and increase top end flow, or, introduce lateral directional swirl to whatever desired angle and intensity in either direction is desired. The functional use of a typical port fuel injector is thereby elevated to a dual function of both tunable fuel and air flow control at the point of induction into a combustion chamber without any modification to existing engine designs or their engine management control systems employed therefore. The flow diverting blade can be configured to divert flow around the intake valve stem, guide and guide boss in such a manner to optimize the overall flow dimension of the induction system of a typical internal combustion engine. The flow diverting blade also provides an effective means by which the proximity and angle of fuel injection, relative to the combustion chamber, can be altered and improved as desired. The flow diverting blade also provides an effective means by which a modest increase in effective fuel injector nozzle pressure and fuel vaporization can be realized during periods of high load.

### BACKGROUND

Swirl air flow generation within the induction tract of the typical Internal combustion (IC) engine has long been recognized as a means to enhance certain desirable performance aspects therein. The goal is to find the perfect balance between the intensity and/or angle of swirl generated and a reduction in the high end flow dimension resulting in reduced top end performance. Further, the optimal preferred lateral direction of the swirl, from either the left or the right, varies with different IC engine configurations. It has also been determined that devices that attempt to generate swirl upstream of the intake valve deliver minimal to negative overall performance results.

Several attempts to create selectively variable intra-port swirl generators have been made such as Sakurai et al, U.S. Pat. No. 4,700,669 to Toyota and Khalighi et al, U.S. Pat. No. 4,827,883 to GM. These devices are designed to allow for on the fly variability and are very complicated and costly to implement and produce. These types of devices require major redesign of existing production engines and would therefore have extremely limited potential as an aftermarket product.

Additionally the ability to direct fuel delivery deeper in the center of an intake port closer to the intake valve and to make use of intra-port air flow dynamics to create specific low pressure low pressure points advantageous to creating a phase change in the fuel to a vapor has been discovered in testing to improve performance and efficiency.

It is to these considerations of ease of selectively variable swirl intensity and/or angle and direction as well as optimal location combined with improved fuel delivery at a low cost and with simplicity, ease of installation into existing IC engines even as an aftermarket add on that the here disclosed invention is specifically designed to address. The here disclosed invention takes advantage of the main obstruction within an intake tract, the intake valve stem, to actually create potential for an increase in top end flow dimension allowing for some additional lateral directional swirl to be introduced and the benefits therefore realized without reducing top end flow dimension allowing for improved top end performance. The here disclosed invention further allows, in certain situations, to actually reduce existing swirl and straighten the flow to affect higher top end flow dimension if so desired and to so with ease.

This application is related to and a continuation of provisional patent application No. 62/176,270 dated Feb. 18, 2015 & No. 62/231,678 dated Jul. 13, 2015 and includes SOME new matter not covered in the previous applications.

### BRIEF SUMMARY OF INVENTION

The typical modern IC engine port fuel injection system utilizes an electromagnetic solenoid based port fuel injector. Such systems generally allow for ease of removal and installation of the port fuel injectors onto the top of the intake manifold. Such systems generally allow for a significant range of free angled rotation of the fuel injector along its center longitudinal axis in the fully seated and installed position without impacting its performance or causing leaks or any other negative issue. By attaching a flow diverting blade to the intra-port tip end of the fuel injector it is possible to take advantage of the typical fuel injector externally selectively variable rotational angle range of motion to allow for ease of manual selection of the angle of the intra-port blade and create the precise intensity and/or angle and/or direction of air and fuel swirl desired for each individual cylinder therein. Further the opportunity to improve the fuel delivery created with the here disclosed invention.

### BRIEF DESCRIPTION OF DRAWINGS

FIG. 1 is an angled see through view of a retro fit blade unit.

FIG. 2 is a solid 3D view of a retro-fit blade unit.

FIG. 3 is a cross sectional side view of a retro-fit blade unit.

FIG. 4 is a cross sectional side view of a retro-fit or integral blade arrangement including a collar with a post engine installation visible section allowing for rotational angle identification.

FIG. 4-A is a front view of the rotational angle identification collar section of FIG. 4.

FIG. 5 is a cross sectional side view of a duel function port fuel injector integral with an intra-port blade system.

### DETAILED DESCRIPTION OF INVENTION

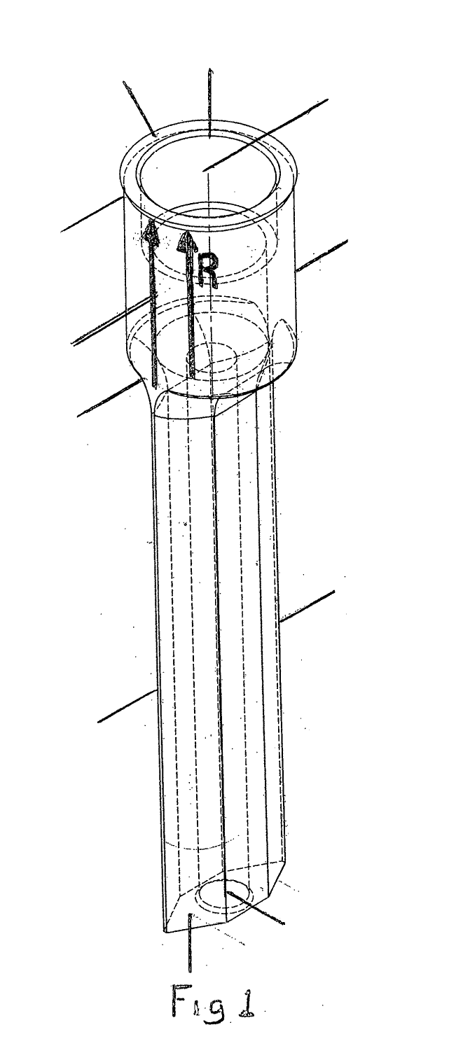

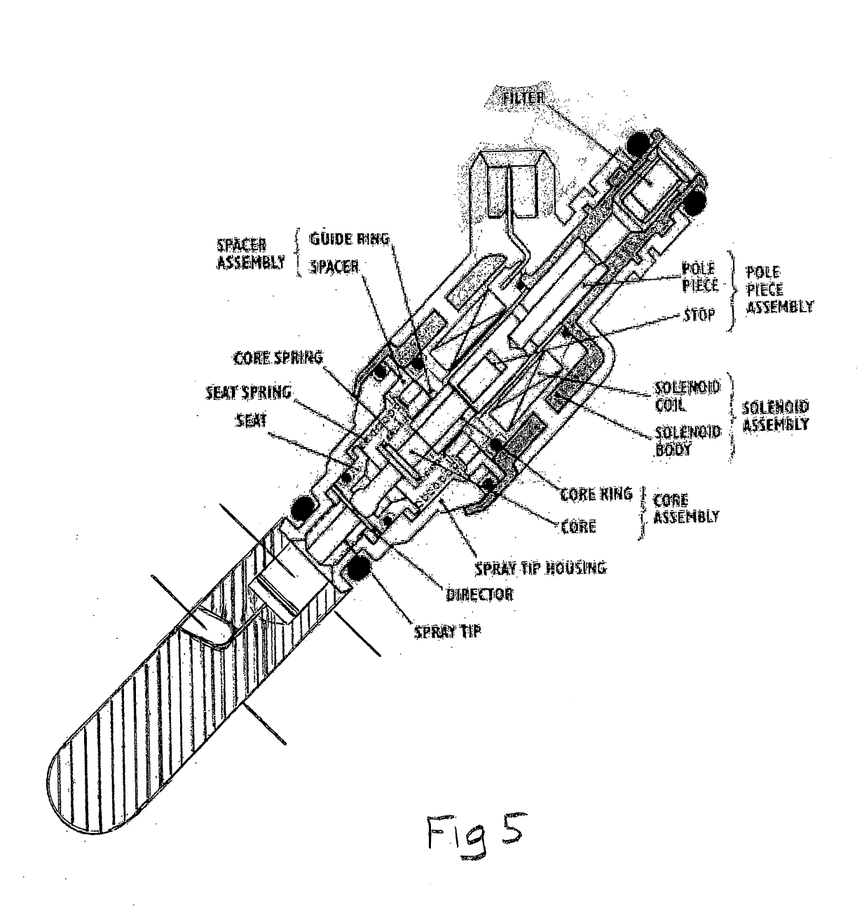

A dual function fuel injector as disclosed herein can be accomplished either by integrating the flow diverting blade as integral to the final construction of a typical port fuel injector as depicted in FIG. 5, OR, through the application of a separate flow diverting blade unit specifically designed for retro-fit onto an existing port fuel injector as depicted in FIGS. 1-4.

In preferred embodiment No. 1 a retro-fit version of a blade unit includes a small protruding lip is incorporated at the top end of the collar (FIGS. 1-4) in order to disallow the blade assembly to become fully disengaged with the fuel injector and/or fall into the intake port.

To aid in the retro-fit installation of the blade unit the collar ID section includes at least two (2) different internal dimension sections and is stepped as depicted in FIGS. 1 & 3. A substantial portion of the initial ID section from the open top end is sized to allow snug slip on application to a fuel injector's nozzle tip end which properly aligns the blade unit before reaching a stepped interference fit section. This allows for final manipulation of the angle of the blade relative to the fuel injector. Once the blade is in proper position the careful application of just enough force to overcome the interference fit section allows for final seating and locked engagement of the blade unit onto the fuel injector (See FIGS. 1 & 3).

To further aid in the final manipulation of the angle of the blade, relative to the fuel injector, visible angle markings upon the outer surface of the blade unit's collar can be applied as depicted in FIG. 1. This can be accomplished by machined groves or laser or other form of etching. If something other than a center mark is desired it may be necessary to identify which cylinder receives a predetermined angle to the right or the left. In the case of certain V-Twin applications it would be helpful to identify which angle applies to the front or rear cylinder as depicted in FIG. 1.

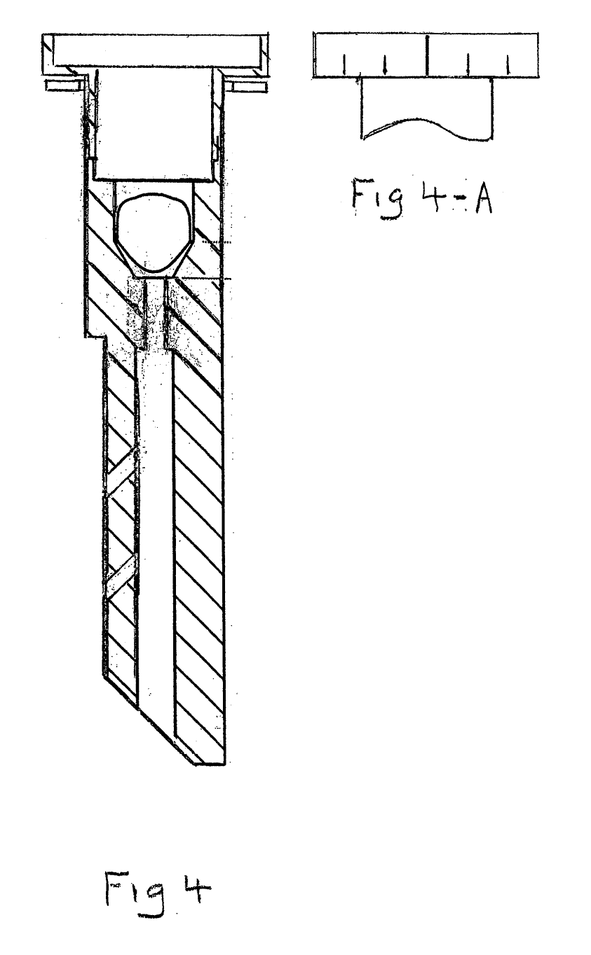

In preferred embodiment No. 2 a retro-fit version of a blade unit includes a means by which the nozzle end's main O-ring seal arrangement is can be by-passed to allow an expanded open end collar section to extend above the fuel injector mounting boss on the intake manifold and therefore be visible after final installation as depicted in FIGS. 4 & 4-A. Angle markings can be applied to this visible section to provide a means to readily and accurately identify the rotational angle of the Duel Function Fuel Injector after installation into a typical IC engine as depicted in FIG. 4-A. The conventional O-ring seal can be replaced with a flat rubber washer type seal as depicted in FIG. 4, or, any other means necessary to effectively seal the fuel injector base.

In preferred embodiment No. 3, whether integral or retro-fit, the said blade unit may be machined or forged or cast or formed of various preferred materials not limited to and including, aluminum, titanium, magnesium, steel, stainless steel, copper, bronze, brass, carbon fiber or plastic.

The blade section itself may be machined or forged or cast or formed in various preferred cross sectional shapes not limited to and including hexagonal (as depicted in FIGS. 1 & 2) or air foil and either straight (as depicted in FIGS. 1-5) or curved, twisted or angled along its length. The blade section could include a smooth, rough or dimpled surface or cross sectional means for flow diversion.

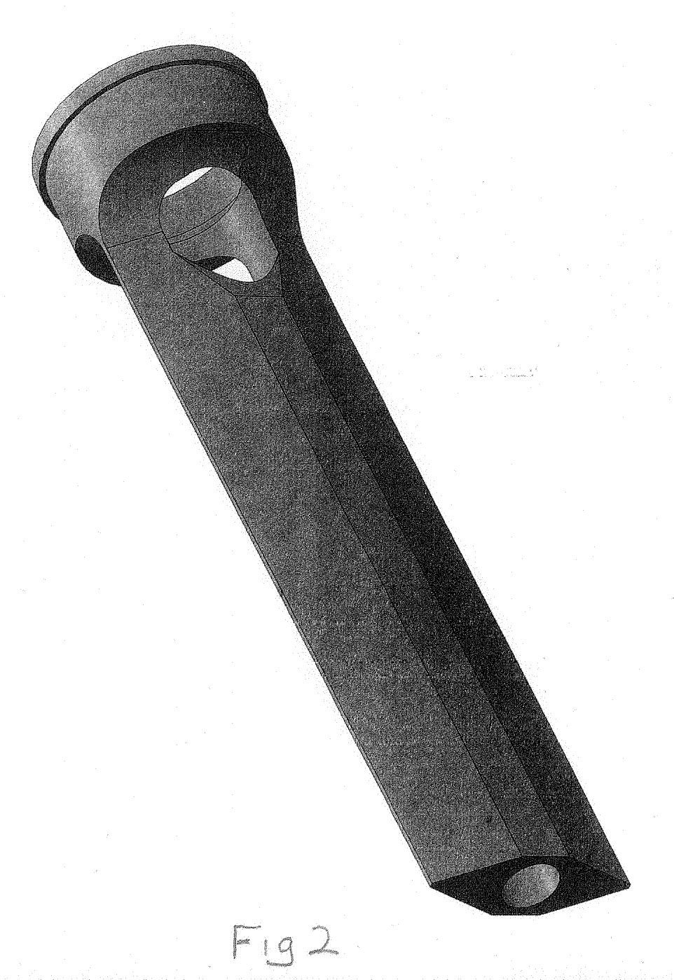

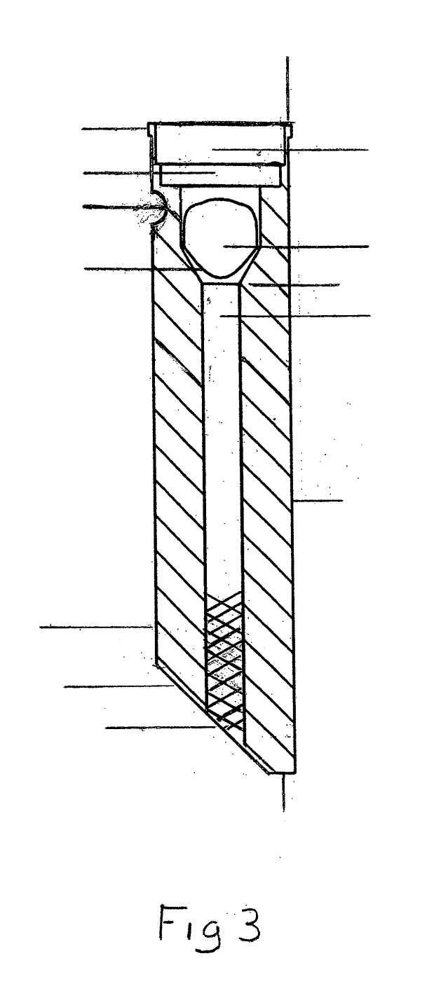

Said embodiment including a means to divert fuel through all or a portion of the length of the blade section by means of a fuel port in various configurations machined therein as depicted in FIGS. 1-5. Said fuel port may be configured with a constricted section with a steep angled entry to form a funneling affect thereunto just below the main fuel injector nozzle as depicted in FIG. 4. This configuration promotes a venturi effect to aid in the breakup and/or vaporization of the fuel. The fuel port may be accompanied with a relief area just below the collar that allows the main fuel port to flow air and fuel and enhance fuel atomization and/or vaporization as depicted in FIGS. 2-4. Said relief area could extend on one side or both through the length of the blade or any portion thereof. Said fuel port may also include machined threads on its distal end in either or both directions as is depicted in FIG. 3 to aid in fuel atomization and/or vaporization. Further, said fuel port can be connected to a sub port(s) at various angles to the main fuel port as depicted in FIG. 4.

Said embodiment including a tapered collar to allow for ease of installation in certain applications.

Said embodiment including a notched relief at various points along the leading or trailing edge of the blade section as depicted in FIG. 3 in order to accommodate any intra port obstructions such as the Chrysler HEMI engine.

Said embodiment including a blade section with an angled distal tip end as depicted in FIGS. 3 & 4. The blade could also include a reduced and/or blunt edge running along all or a portion of its length thereof as depicted in FIG. 4.

Any and/or all embodiments may include a main fuel injector nozzle designed to inject fuel in a pattern designed to enhance the overall performance of the duel function fuel injector.

What is claimed is:

1. A dual function electromagnetic intake port fuel injector for internal combustion engines comprising:
a. An electromagnetic intake port fuel injector with a fuel spray nozzle tip end,
b. an intra-port air flow diversion means securely attached to and extending past the fuel spray nozzle tip end of an electromagnetic intake port fuel injector means.

2. The dual function port fuel injector assembly in claim 1 including a means to prevent the flow diversion means form disengagement with the port fuel injector means or to prevent unintended free incursion into the intake port of an internal combustion engine.

3. The dual function port fuel injector assembly in claim 1 whereas the intra-port air flow diversion means is designed with a collar designed to retro-fit the air flow diversion means securely upon an intake port fuel injector's fuel spray nozzle tip end comprising:
a. A locking lip on its outer circumference to prevent unintended free incursion of the flow diversion means into the intake port of an internal combustion engine.

4. The dual function port fuel injector assembly in claims 1-3 including visible marks upon the outer circumference of a collar in order to indicate angled alignment of the intra-port air flow diversion means to the intake port fuel injector.

5. The dual function port fuel injector assembly in claims 1-4 including a collar with a stepped internal dimension defining at least two (2) internal dimensions.

6. The dual function port fuel injector assembly in claims 1-5 including a collar with a stepped external dimension defining at least two (2) external dimensions including visible marks in order to indicate angled alignment of the dual function fuel injector assembly after installation in an internal combustion engine.

7. A dual function electromagnetic intake port fuel injector for internal combustion engines comprising:
a. An electromagnetic intake port fuel injector with a fuel spray nozzle tip end,
b. an intra-port air flow diversion means securely attached to and extending past the fuel spray nozzle tip end of an electromagnetic intake port fuel injector means,
c. an intra-port fuel flow diversion means securely attached to and extending past the fuel spray nozzle tip end of an electromagnetic intake port fuel injector means.

8. The dual function port fuel injector assembly in claim 7 including a means to prevent the flow diversion means form disengagement with the port fuel injector means or to prevent unintended free incursion into the intake port of an internal combustion engine.

9. The dual function port fuel injector assembly in claim 7 whereas the intra-port air flow diversion means is designed with a collar designed to retro-fit the air flow diversion means securely upon an intake port fuel injector's fuel spray nozzle tip end comprising:
a. A locking lip on its outer circumference to prevent unintended free incursion of the flow diversion means into the intake port of an internal combustion engine.

10. The dual function port fuel injector assembly in claims 7-9 including visible marks upon the outer circumference of a collar in order to indicate angled alignment of the intra-port air flow diversion means to the intake port fuel injector.

11. The dual function port fuel injector assembly in claims 7-10 including a collar with a stepped internal dimension defining at least two (2) internal dimensions.

12. The dual function port fuel injector assembly in claims 7-11 including a collar with a stepped external dimension defining at least two (2) external dimensions including visible marks in order to indicate angled alignment of the dual function fuel injector assembly after installation in an internal combustion engine.

13. The dual function port fuel injector assembly in claim 7 including an intra-port air flow diversion means securely attached to and extending past the fuel spray nozzle tip end of an electromagnetic intake port fuel injector with a fuel port means therein.

14. The dual function port fuel injector assembly in claims 7 & 13 including a constricted portion of the said fuel port means forming a venturi therein.

15. The dual function port fuel injector assembly in claims 7, 13 & 14 including a means of disrupting and dispersing internal fuel flow through the said fuel port means.

16. The dual function port fuel injector assembly in claims 7, 13-15 including an open air relief means to allow air to mix with fuel within the said fuel port means.

17. The dual function port fuel injector assembly in claims 1-16 including an intra-port air flow diversion means securely attached to and extending past the fuel spray nozzle tip end of an electromagnetic intake port fuel injector means including a notched relief upon its outer surface forming an edge.
